(19) United States
(12) Patent Application Publication
(10) Pub. No.: US 2012/0315377 A1
(43) Pub. Date: Dec. 13, 2012

(54) APPARATUS, SYSTEM, AND METHOD FOR AUTOMATED DISPENSING OF A SUBSTANCE ON ONE OR MORE SEEDS

(75) Inventors: Amy D. Blahnik, Johnston, IA (US); Jason M. Cope, Ankeny, IA (US); Bradley T. McAvoy, West Des Moines, IA (US); Gang Wan, Grimes, IA (US)

(73) Assignee: Pioneer Hi-Bred International, Inc.

(21) Appl. No.: 13/156,901

(22) Filed: Jun. 9, 2011

(51) Int. Cl. A01N 3/00; B05C 5/00

(52) U.S. Cl. 427/4; 118/323

(57) ABSTRACT

Embodiments of the present invention provide automated apparatus, systems, and methods for dispensing a substance on a seed. An example embodiment provides a system for automated dispensing of a substance on a seed. The system comprises a seed container with a plurality of compartments each configured to retain a seed. The system further comprises a supply tank configured to retain the substance. The system also comprises at least one dispensing tip configured to dispense the substance and a pump connected to the supply tank and to the dispensing tip. The pump is configured to pump the substance from the supply tank to the dispensing tip. The system further comprises a controller configured to move at least one of the seed container or the dispensing tip relative to the other and to direct the pump to pump the substance into a compartment of the seed container.

### FIELD OF THE INVENTION

Various embodiments of the present invention relate generally to systems, methods, and apparatuses useful for seed research. More specifically, embodiments of the present invention provide systems, methods, and apparatuses for dispensing a substance on one or more seeds in a seed package.

### BACKGROUND OF THE INVENTION

Research of plant seeds is common in the agricultural seed industry. In particular, a company in the agricultural seed industry may generate one or more research plots in order to evaluate certain seed varieties. Such seed varieties may include, but need not be limited to, seeds from a specific source, genotype, population, and/or breeding line. In such a manner, researchers may evaluate characteristics of the plants growing in the research plot, as well as characteristics of any crops produced from the plants.

Seeds, such as those corresponding to a research plot, are often ultimately placed in seed packages, or blister packs, for storage, identification, and other research functions. In some applications, substances may be previously applied to the seeds in order to aid in research. For example, a magnetic substance may be applied to a whole cob of corn seeds. The seeds could then be separated from the cob and easily collected and/or controlled by magnets due to the magnetic properties in the substance. Seeds that are easy to collect and/or control in such a manner are beneficial for research purposes, such as seed sampling. However, further improvements in apparatuses, systems, and methods for applying a substance to a seed are desirable.

### BRIEF SUMMARY

There may be a number of reasons or advantages to dispensing a substance on a seed. For example, dispensing a seed treatment substance onto a seed may be effective in encouraging that seed to grow, or protecting the seed from pathogens, insects, mold, and/or fungus. In some cases it may be beneficial to identify or control the seeds based on a coating applied to the seeds. In particular, applying a magnetic substance to a seed may allow a machine or tool with magnetic attraction properties to easily control the seed. Such a machine could be used to easily pick up the seed, or a number of seeds, and allow for sampling or research to be performed on the seed. The magnetic attraction properties could secure the seed while a portion or sample of the seed could be extracted or otherwise removed for further testing and analysis. In some cases, often known as destructive seed sampling, at least a portion of the seed embryo may be removed for testing and analysis. In other cases, often known as non-destructive sampling, a small portion of the seed may be removed for testing while a sustainable seed embryo remains.

Embodiments of the present invention provide automated apparatuses, systems, and methods for dispensing of a substance on a seed. An example embodiment provides a system for automated dispensing of a substance on a seed. The system comprises a seed container with a plurality of compartments each configured to retain a seed. The system further comprises a supply tank configured to retain the substance. The system also comprises at least one dispensing tip configured to dispense the substance and a pump connected to the supply tank and to the dispensing tip. The pump is configured to pump the substance from the supply tank to the dispensing tip. The system further comprises a controller configured to move at least one of the seed container or the dispensing tip relative to the other and to direct the pump to pump the substance into a compartment of the seed container.

In another embodiment, a method for automatically dispensing a substance on a seed is provided. The method comprises moving at least one of a seed container or a dispensing tip relative to the other. The seed container comprises a plurality of compartments each compartment configured to retain a seed. The dispensing tip is connected to a pump and the pump is connected to a supply tank, which is configured to retain the substance. The dispensing tip is configured to dispense the substance. The method further comprises directing the pump to pump the substance into a compartment of the seed container.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of an automated dispensing unit, in accordance with some embodiments discussed herein;

FIG. 2 illustrates a system for automated dispensing of a substance, in accordance with some embodiments discussed herein;

FIG. 3 is a perspective view of a seed package, in accordance with some embodiments discussed herein;

FIG. 4 is an exploded cross-sectional view of a seed package and a seed package tray, in accordance with some embodiments discussed herein;

FIG. 4A is a cross-sectional view of the seed package shown in FIG. 4 engaged with the seed package tray shown in FIG. 4, in accordance with some embodiments discussed herein;

FIG. 5 is a detailed view of a dispensing portion of the dispensing unit shown in FIG. 1, in accordance with some embodiments discussed herein;

FIG. 6 is a detailed view of the dispensing portion shown in FIG. 5 with the dispensing hoses removed for ease of reference, wherein a dispensing arm of the dispensing portion is positioned over a bath, in accordance with some embodiments discussed herein;

FIG. 7 is a perspective view of an automated dispensing unit, in accordance with some embodiments discussed herein; and

FIG. 8 illustrates a flow chart of a method for automated dispensing of a substance on a seed, in accordance with some embodiments discussed herein; and

FIG. 9 illustrates a flow chart of another embodiment of a method for automated dispensing of a substance on a seed, in accordance with some embodiments discussed herein.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

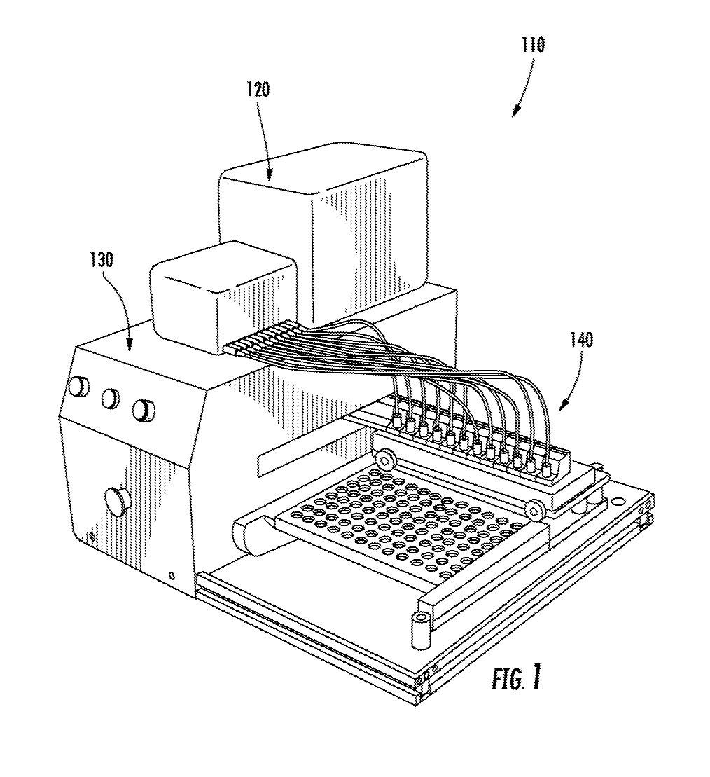

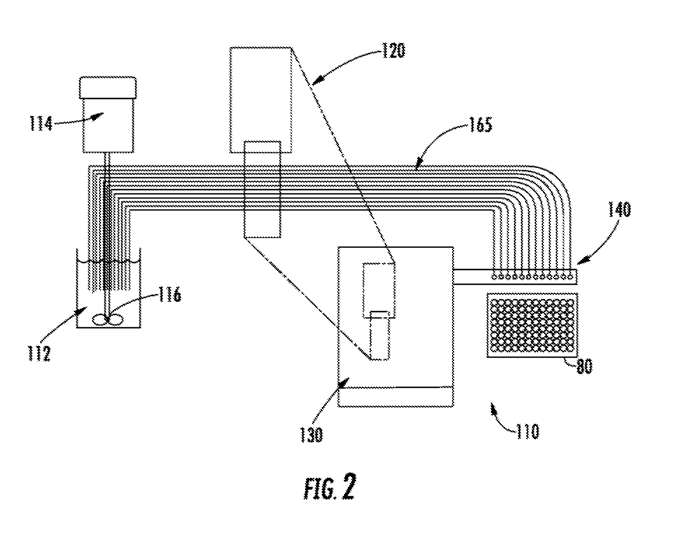

FIG. 1 shows an example embodiment of a dispensing unit 110 designed for dispensing a substance on a seed. The dispensing unit 110 may comprise a pump 120, a controller 130, and a dispensing portion 140. In some embodiments, with reference to FIG. 2, the dispensing unit 110 may also comprise a supply tank 112. Moreover, in various embodiments, the dispensing unit 110 may also comprise an agitator 114. As described herein, various components of the dispensing unit 110, including the pump 120, controller 130, dispensing portion 140, supply tank 112, and/or agitator 114, may form a system for dispensing a substance on a seed.

In storing and research operations of seeds, individual seeds are often stored in seed packages (e.g., blister packs). Packaging seeds in such a manner has a number of advantages, such as allowing for easy identification of a seed or bulking seeds together that have common characteristics. Thus, in some embodiments, the dispensing unit 110 is configured to dispense a substance on individual seeds stored in a seed package. In the depicted embodiment, the dispensing unit 110 is configured to dispense a substance on seeds placed in a 12×8 compartment seed package.

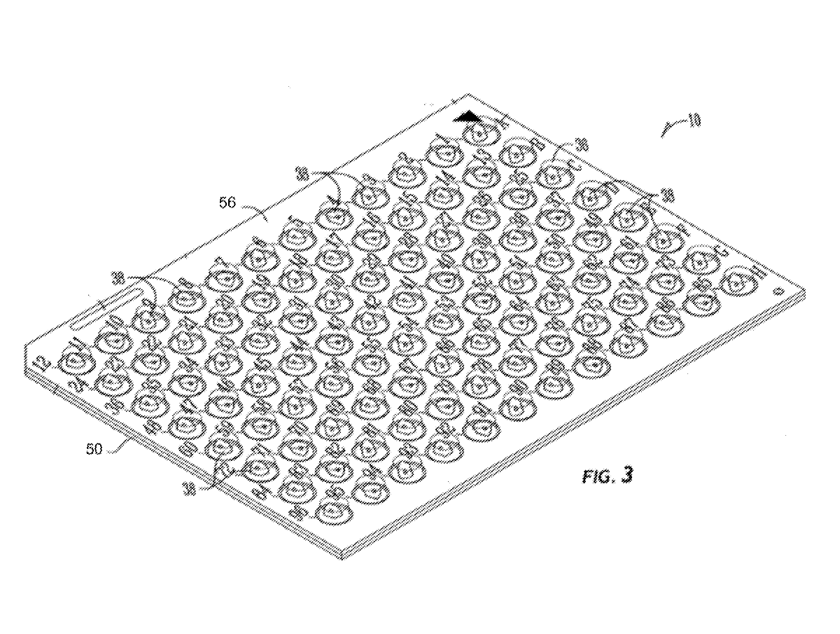

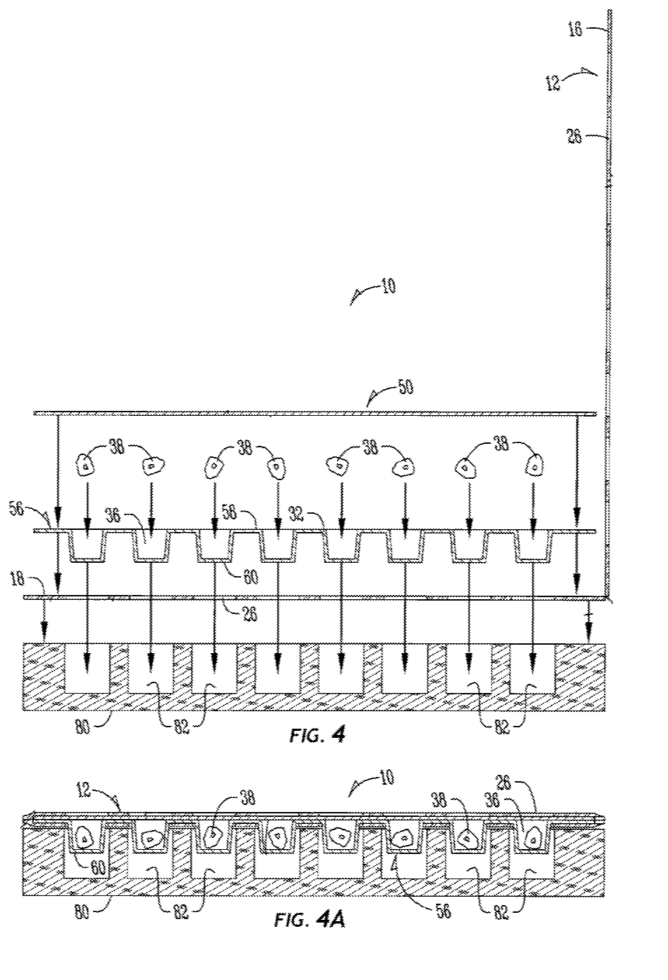

FIGS. 3-4 illustrate an example of a seed package 10 that may be used with the dispensing unit 110. The seed package 10 may comprise a compartment layer 56 with at least one compartment 36. In the depicted embodiment, the seed package 10 comprises a plurality or compartments 36. With reference to FIG. 4, each compartment 36 is defined such that it opens toward the inner surface 58 and extends away from the outer surface 60 of the compartment layer 56. In some embodiments, the plurality of compartments 36 may form an ordered array of compartments 36 having a particular pattern or arrangement. The ordered array may be selected and arranged for a variety of reasons which could prove advantages, including facilitating more efficient and accurate identification or management of articles, such as seeds 38, in each compartment 36. In particular, each seed package 10 may comprise a row/column configuration with any number of rows or columns. For example, the seed package 10 may define a 12×8 configuration of compartments 36. In some embodiments, the seed package 10 may be configured with a plurality of compartments 36 arranged in other configurations (e.g., staggered rows and/or columns, honeycomb, circular, etc.). It should be noted that although in the depicted embodiment, the seeds 38 are corn (maize) seeds, the present invention may be applicable to various other seeds, peas, beans, etc., including, for example, but not limited to, alfalfa, sunflower, Brassica, soybean, cotton, canola, safflower, peanut, sorghum, wheat, millet, tobacco, barley, rice, rye, flax, safflower, palm, coconut, guar, locust bean, fenugreek, soybean, garden beans, cowpea, mungbean, lima bean, fava bean, lentils, chickpeas, etc.

In some embodiments, the seed package 10 may comprise a sealant layer 50 adapted to close off each compartment 36. The sealant layer 50 may include such materials as plastics (e.g., cellophane, saran wraps), foils, paper, non-woven fiber, dissolvable layers, bio-plastics, starch-based material or other material suitable to close off each compartment. Other materials may also be used as a sealant layer 50, such as gels (e.g., gelatin, acrylamide, and agarose) and wax (e.g., paraffin wax). In some embodiments, the sealant layer 50 may be rupturable.

In various embodiments, the seed package 10 may further comprise an outer layer 12 configured to surround the compartment layer 56 and/or sealant layer 50. The outer layer 12 may be formed of a rigid, or semi-rigid, material. The outer layer 12 may have a plurality of apertures 26 sized such that each compartment 36 aligns with each aperture 26. In the depicted embodiment, the outer layer 12 comprises a first half 18 and a second half 16. The first half 18 and second half 16 may each have complimentary apertures 26 such that folding of the second half 16 onto the first half 18 aligns the apertures 26. In some embodiments, the first half 18 and second half 16 may be folded together around the compartment layer 56 and/or sealant layer 50 to form a rigid, or semi-rigid, seed package 10. In such an embodiment, the apertures 26 on the first half 18 receive the bottom half of each compartment 36 and the apertures 26 on the second half 16 align with the openings of each compartment 36.

With reference to FIGS. 4 and 4A, the seed package 10, or seed container, may be configured to engage with a seed package tray 80 such that the seed package 10 is securely positioned inside the seed package tray 80. The seed package 10, as noted above, may be flimsy or otherwise flexible and thus, it may be desirable to position the seed package 10 in the seed package tray 80 to maintain a certain level of rigidity and/or sturdiness for operation of the dispensing unit 110.

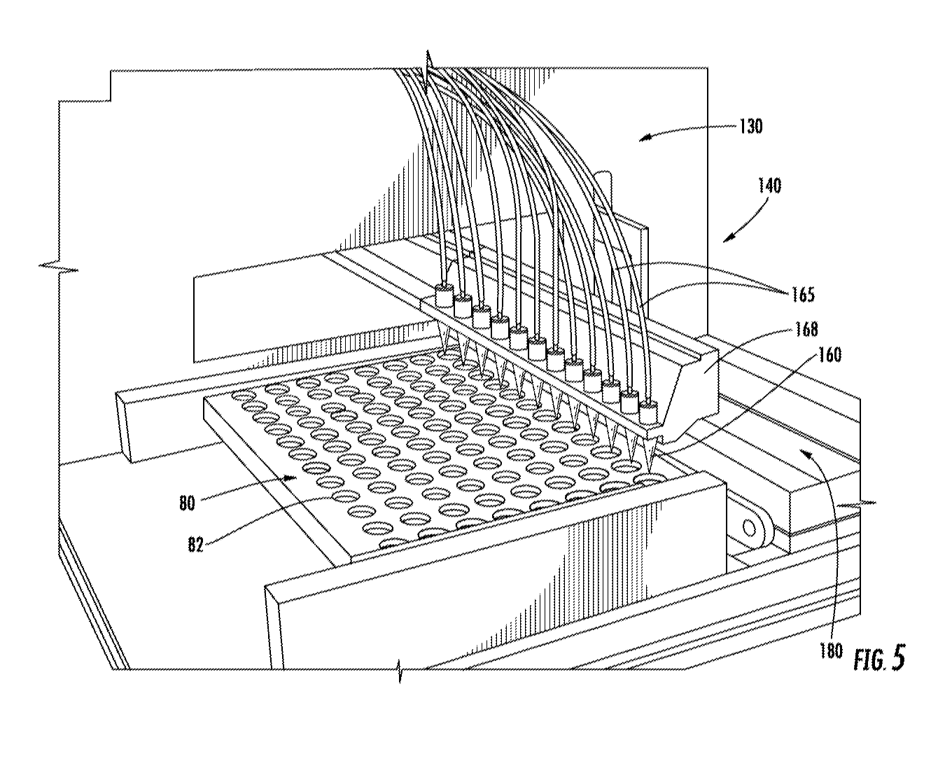

In the depicted embodiment, the seed package tray 80 comprises at least one slot 82 configured to receive an individual compartment 36 of the seed package 10. As shown in FIG. 5, the seed package tray 80 is positioned in the dispensing unit 110 to properly position each compartment 36 of the seed package 10 for dispensing. For example, an operator of the dispensing unit 110 may simply engage a seed package 10 with the seed package tray 80 such that the compartments 36 of the seed package 10 fit inside the slots 82 of the seed package tray 80. As such, each compartment 36 will be properly positioned for dispensing during operation of the dispensing unit 110. Additionally or alternatively, the seed package tray 80 may be removably fixed to the dispensing unit 110. For example, an operator may remove the seed package tray 80 from the dispensing unit 110 and insert a seed package 10 inside the seed package tray 80 before placing the seed package tray 80 back into the dispensing unit 110 for operation.

As noted above, applying a substance to a seed may be beneficial for seed sampling or other research. Thus, in some embodiments, the dispensing unit 110 may be configured to dispense a substance on a seed, such as seeds 38 in a seed package 10. The pump 120 of the dispensing unit 110 may be connected to the supply tank 112 and may be configured to pump a substance from the supply tank 112 to the dispensing portion 140 of the dispensing unit 110 and further onto the seeds 38. In some embodiments, the pump 120 may be configured to pump the substance from the supply tank 112 through at least one dispensing hose 165. In the depicted embodiment of FIG. 2, the pump 120 is configured to pump the substance from the supply tank 112 to the dispensing portion 140 through a plurality of dispensing hoses 165. In some embodiments, the pump 120 may be a peristaltic pump with at least one channel. In the depicted embodiment, the pump 120 is a peristaltic pump with twelve channels that correspond to twelve dispensing hoses 165.

In some embodiments, the supply tank 112 may be configured to hold a magnetic substance. In some embodiments, the magnetic substance may comprise magnetic particles that settle out of solution without stirring. Thus, an agitator 114 may be provided to keep the magnetic particles mixed inside the magnetic substance for proper dispensing. As shown in FIG. 2, the agitator 114 may comprise a stirring mechanism 116 that is positioned inside the supply tank 112 and configured to stir the magnetic substance. For example, the agitator 114 may comprise a variable speed motor attached to the stirring mechanism 116. The agitator 114 may be configured to constantly stir the magnetic substance. Additionally or alternatively, the agitator 114 may be in communication with the controller 130 and may be configured to stir the magnetic substance inside the supply tank 112 upon instruction from the controller 130. In some embodiments, the substance may comprise at least one of a nutrient, protective treatment, and magnetic paint. For example, in some embodiments, the substance may comprise a seed treatment.

The dispensing portion 140 may be configured to direct the substance being dispensed onto each seed. In some embodiments, the dispensing portion 140 may comprise at least one dispensing tip 160 configured to dispense the substance. The dispensing tip 160 may be connected to a dispensing hose 165 that is fluidly connected to the supply tank 112 and configured to carry the substance from the supply tank 112 to the dispensing tip 160. With reference to FIG. 5, the dispensing portion 140 may comprise a plurality of dispensing tips 160 connected to a plurality of corresponding dispensing hoses 165. In the depicted embodiment, the dispensing portion 140 comprises twelve dispensing tips 160 with twelve corresponding dispensing hoses 165.

The dispensing tip 160 may be configured to direct the substance onto the seed. In various embodiments, the dispensing tips 160 may have a specific caliber to aid in correct dispensing of the substance. There are many considerations or factors in determining the desired caliber of the dispensing tip 160. For example, in some embodiments, the compartment 36 storing the seed 38 is small and dispensing of the substance onto the seed may require precision. As such, each dispensing tip 160 may define a funnel shape such that the substance is accurately dispensed onto the seed. Moreover, in some embodiments, the seed package 10 containing the seeds 38 may comprise a sealant layer 50. The point of the dispensing tip 160 may be structured to puncture or rupture the sealant layer 50 such that the substance can be dispensed into the compartment 36 and onto the seed 38 stored inside. Additionally or alternatively, the characteristics of the substance being pumped through the dispensing tip 160 may help determine the desired caliber. For example, a magnetic substance may require a different caliber dispensing tip than a seed treatment substance. As such, many factors are important for determining the proper caliber of the dispensing tip 160 (e.g., paint viscosity, flow rate, fluid type, etc.).

The dispensing portion 140 may comprise a dispensing arm 168. In some embodiments, the dispensing arm 168 may be configured to facilitate and maintain connection of the dispensing hoses 165 to each corresponding dispensing tip 160. For example, the dispensing arm 168 may be configured to align each dispensing hose 165 with each dispensing tip 160 such that the substance can be pumped from the dispensing hose 165 into the dispensing tip 160.

In some embodiments, the dispensing arm 168 may be configured to position the dispensing tip 160 so as to align the dispensing tip 160 with a seed to be dispensed upon. For example, with reference to FIG. 5, the dispensing arm 168 may be configured to align the dispensing tip 160 with a slot 82 of the seed package tray 80. As such, when a seed package 10 is properly engaged with the seed package tray 80, and the seed compartment 36 is positioned within a slot 82, the dispensing tip 160 will be aligned with a seed compartment 36 and, thus, the seed 38 contained therein. In some embodiments, the dispensing arm 168 may be configured to position a row of dispensing tips 160 such that the dispensing tips 160 align with a row of slots 82 and/or seed compartments 36.

In some embodiments, the dispensing arm 168 may be configured to translate to align the dispensing tip 160 with a slot 82 and/or seed compartment 36. For example, in the depicted embodiment, the dispensing arm 168 may be configured to translate longitudinally across the seed package tray 80 to align the dispensing tip 160 with a slot 82 and/or seed compartment 36. In such embodiments, the dispensing arm 168 may be in communication with the controller 130 such that the controller 130 may instruct the dispensing arm 168 to align a dispensing tip 160 with a specific slot 82 and/or seed compartment 36, or row of seed compartments. Additionally, the controller 130 may also be configured to instruct the dispensing arm 168 to translate to align the dispensing tip 160 with a different slot 82 and/or seed compartment 36, or row of seed compartments. In various embodiments, the dispensing arm 168 may be configured to raise or lower. As such, in some embodiments, the dispensing arm 168 may be configured to raise or lower to align the dispensing tip 160 with a slot 82 and/or seed compartment 36. In some embodiments, the seed package 10 and/or seed package tray 80 may be configured to move in order to align the dispensing tip 160 with a slot 82 and/or seed compartment 36. For example, the controller 130 may be configured to translate the seed package 10 and/or seed package tray 80 to align the dispensing tip 160 with a slot 82 and/or seed compartment 36.

In the depicted embodiment of FIG. 5, the dispensing arm 168 is configured to position the dispensing tips 160 in a row such that each dispensing tip aligns with a slot 82 of the seed package tray 80. Moreover, the dispensing arm 168 is further configured to move longitudinally across the seed package tray 80 to align the dispensing tips 160 with a different row of slots 82. For example, during operation of the dispensing unit 110, the dispensing arm 168 may be configured to selectively align the dispensing tips 160 with each row of slots 82 of the seed package tray 80. As such, the pump 120 may be configured to selectively pump the substance through the dispensing tips 160 as the dispensing tips 160 are selectively aligned with each row of slots 82 of the seed package tray 80. In such a manner, when a seed package 10 is positioned in the seed package tray 80 and the dispensing unit 110 is turned on, the dispensing unit 110 may be configured to pump the substance onto each seed 38 in a seed compartment 36 in the seed package 10. In the depicted embodiment, the dispensing arm 168 is configured to position and selectively align twelve dispensing tips 160 over eight different rows of slots 82 of the seed package tray 80.

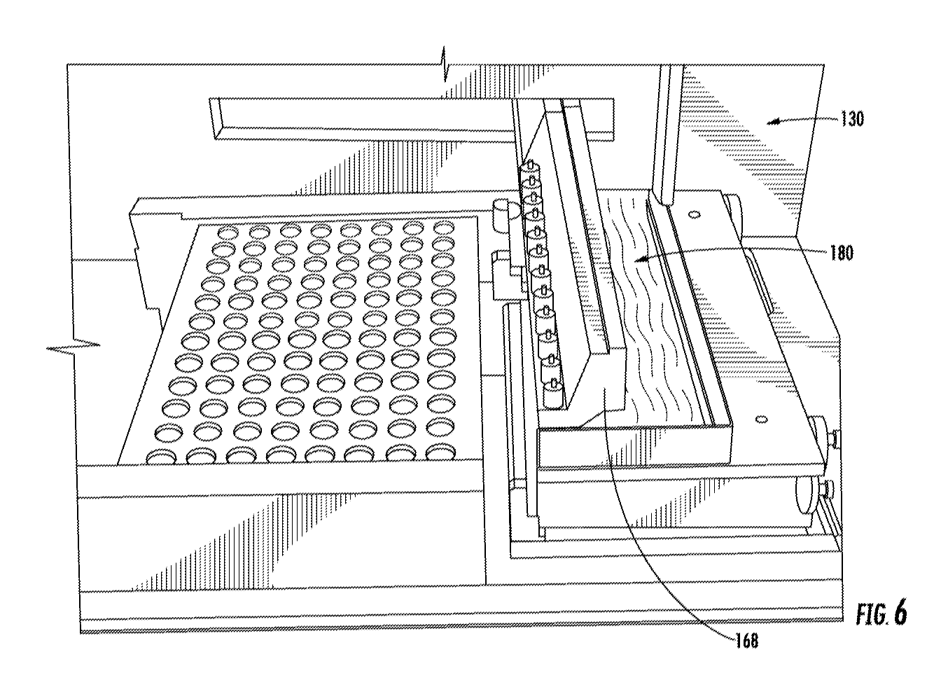

In some embodiments, the dispensing arm 168 may also be configured to engage the dispensing tips 160 with a bath 180. As the substance is pumped onto the seeds, a residue may be left on each dispensing tip 160. In some embodiments, such as those that are pumping a magnetic substance, the residue may contain paint that can dry quickly from exposure to the air, often causing the dispensing tips 160 to clog, thereby hindering future dispensing. To prevent drying of the substance on the dispensing tips 160 some embodiments of the dispensing unit 110 may be configured to submerge the dispensing tips 160 in the bath 180. In the depicted embodiment of FIG. 6, the bath 180 comprises water. In various embodiments, the bath may comprise a substance other than water (e.g., one or more cleaning solutions, alcohol, etc.).

In some embodiments, with reference to FIG. 6, the dispensing arm 168 may be configured to move the dispensing tips 160 over the bath 180 and submerge the dispensing tips 160 in the bath 180. In particular, in some embodiments, the dispensing arm 168 may be configured to automatically submerge the dispensing tips 160 in the bath 180 while the dispensing unit 110 is idle. Additionally or alternatively, the dispensing arm 168 may be configured to submerge the dispensing tips 160 in the bath 180 after dispensing the substance into each row of slots 82 of the seed package tray 80.

In some embodiments, the bath 180 may be configured to be moved into and out of engagement with the dispensing tips 160. For example, the dispensing arm 168 may be configured to move the dispensing tips 160 over the bath 180 and the bath 180 may be configured to raise to effect submerging of the dispensing tips 168 in the bath 180. Additionally, the bath 180 may be configured to be moved (e.g., up and down) to allow for easy removal and/or changing of the water in the bath 180. In various embodiments, the bath 180 may be in communication with the controller 130 such that the controller 130 may be configured to control/direct movement of the bath 180.

Additionally or alternatively, the dispensing unit 110 may be configured to purge the dispensing tips 160 in the bath 180. For example, while the dispensing tips 160 are at least partially submerged in the bath 180, the controller 130 may be configured to pump the dispensing tips 160 such that any residue left in the dispensing tips 160 and/or dispensing hoses 165 may be further cleared from the dispensing tips 160 and/or dispensing hoses 165. Such a procedure can be beneficial for preventing the magnetic substance (or other substance) from drying on or clogging the dispensing tips 160 and/or dispensing hoses 165. In some embodiments, the controller 130 may be configured to purge the dispensing tips 160 before pumping the substance onto the seeds. In some embodiments, the controller 130 may be configured to purge the dispensing tips 160 after submerging into the bath 180.

Additionally, in some embodiments, the dispensing tips 160 may be replaceable. In particular, in various embodiments, some of the dispensing tips 160 may become clogged or worn out. This may occur even with submerging the dispensing tips 160 in the bath 180. Therefore, replacement of the dispensing tip 160 may be desired for optimal dispensing of the substance through the dispensing tips 160. In some embodiments, in order to facilitate replacing of the dispensing tips 160, the dispensing arm 168 may be configured to move (e.g., up, down, longitudinally, etc.) to allow an operator to easily access, remove, and replace the dispensing tips 160.

The controller 130 may be in communication with the components of the dispensing unit 110 and be configured to control, direct, and/or instruct the components to perform functions. In some embodiments, the controller 130 may be in communication with the pump 120, agitator 114, dispensing portion 140, dispensing arm 168, and/or bath 180. As such, as noted above, the controller 130 may be configured to direct the pump 120 to turn on and/or off to pump the substance to the dispensing portion 140. Further, the controller 130 may also be configured to direct the agitator to turn on and/or off to stir the substance. The controller 130 may also be configured to control movement of the dispensing arm 168. For example, the controller 130 may be configured to move the dispensing arm 168 such that the dispensing tips 160 align with a slot 82 in the seed package tray 80. Moreover, the controller 130 may be configured to move the dispensing arm 168 over the bath 180 and move the dispensing arm 168 such that the dispensing tips 160 submerge in the bath 180. Additionally or alternatively, the controller 130 may be configured to move the seed package 10 and/or seed package tray 80 such that each seed 38 aligns with a dispensing tip 160 for dispensing of the substance. Furthermore, as noted above, the controller 130 may be configured to move the bath 180, such as to submerge the dispensing tips 160 in the bath 180.

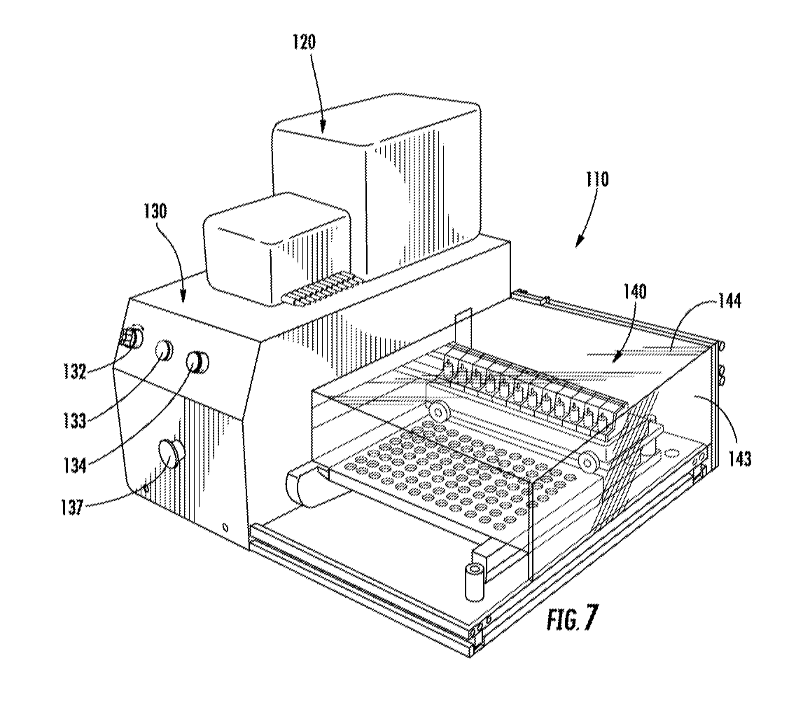

In some embodiments, the controller 130 may comprise a processor and/or memory. In some embodiments, the controller 130 may be configured to automatically control/direct operation of the dispensing unit 110. For example, with reference to FIG. 7, an operator may simply press, or rotate, an ON/OFF button 132 to turn the dispensing unit 110 on or off. In some embodiments, once the dispensing unit 110 is turned on, the controller 130 may direct the components of the unit to automatically dispense the substance onto the seeds and return to an idle position. As such, the controller 130 may be configured to automatically dispense a substance onto a seed in accordance with embodiments as described herein.

In various embodiments, the controller 130 may also be in communication with other buttons that allow an operator of the dispensing unit 110 to control other functions. For example, with reference to FIG. 7, the dispensing unit 110 may comprise a START button 133 configured to initiate a cycle of automatic dispensing of the substance into each seed compartment 36 of a seed package 10. Each cycle may comprise aligning the dispensing tips 160 over a row of seed compartments 36 and dispensing the substance into each seed compartment 36. The cycle may further comprise aligning the dispensing tips 160 with another row of seed compartments 36 and dispensing the substance into that row of seed compartments 36. Then, after every row has been aligned and each compartment dispensed with the substance, the cycle may further comprise submerging the dispensing tips 160 into the bath 180.

The dispensing unit 110 may also comprise a BATH TOGGLE button 134 configured to raise or lower the bath 180. In some embodiments, the BATH TOGGLE button 134 may be used to move the bath 180 for cleaning purposes. For example, the bath 180 may be configured to translate away from the dispensing portion 140 such that the water in the bath 180 may be changed.

In some embodiments, the dispensing unit 110 may comprise an STOP button 137 configured to stop operation of the dispensing unit 110. The STOP button 137 operates as a safety feature for the operator, such that operation of the dispensing unit 110 can be substantially immediately ceased, such as in an emergency.

Likewise, as safety is important with machinery such as the dispensing unit 110, some embodiments may include a case 143. As shown in FIG. 7, the case 143 may be configured to be placed over the dispensing portion 140 to protect the components of the dispensing portion 140 as well as the operator controlling operation of the dispensing unit 110. Thus, in some embodiments, the case 143 may be positioned over the dispensing portion 140 while still allowing operation of the dispensing unit 110 to take place. In the depicted embodiment, the case 143 comprises a top surface 144 that may be opened by the operator to access the seed package tray 80 before or after completion of operation of the dispensing unit 110 (e.g., after operation of a cycle). For example, the operator can lift the top surface 144, remove the seed package tray 80 and insert a seed package 10 into the seed package tray 80. Then, the operator can reposition the seed package tray 80 into the case 143 and begin operation of the dispensing unit 110. In some embodiments, the case 143 may comprise plastic material. In various embodiments, the case 143 may comprise glass material. In some embodiments, the case 143 may be configured such that the seed package tray 80 may be removed while the case 143 is still covering the dispensing portion 140. For example, the operator may slide the seed package tray 80 out from underneath the case 143, place the seed package 10 into the seed package tray 80, slide the seed package tray 80 back into position under the case 143, and then begin operation of the dispensing unit 110. In some embodiments, as a further safety measure, the dispensing unit 110 may not fully operate unless the case 143 is properly positioned.

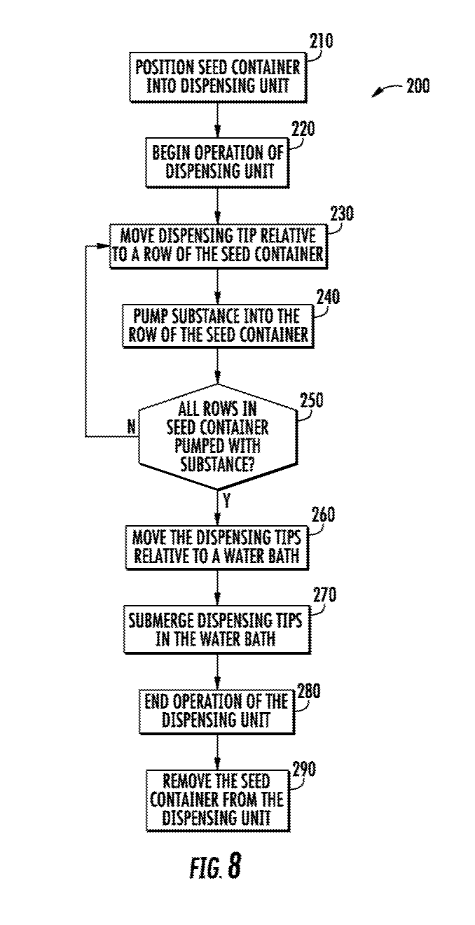

Embodiments of related methods are further provided herein. In this regard, FIG. 8 illustrates an embodiment of a method 200 of dispensing a substance on a seed. Embodiments of a method for dispensing a substance on a seed may be performed by embodiments of the present invention described herein, such as embodiments of the dispensing unit 110 described above. As illustrated in the depicted embodiment of FIG. 8, the method 200 may comprise positioning a seed container into the dispensing unit at operation 210. Further, the method may include beginning operation of the dispensing unit at operation 220. Additionally, the method may include moving the dispensing tip relative to a row of seed compartments of the seed container at operation 230. The method may also include pumping the substance into the row of seed compartments of the seed container at operation 240.

The method may further include determining if all the rows of seed compartments in the seed container have been pumped with the substance at operation 250. If not all of the rows of seed compartments in the seed container have been pumped with the substance, the method may comprise returning to operation 230. If, however, all of the rows of the seed compartments in the seed container have been pumped with the substance, the method may comprise moving the dispensing tips relative to a bath at operation 260. The method may also then include submerging the dispensing tips in the bath at operation 270. In some embodiments, the method may comprise purging the dispensing tips at operation 275. Although in the depicted embodiment the purging operation 275 is shown in a particular location, in various embodiments additionally or alternatively purging may occur at any other time. Next, the method may include ending operation of the dispensing unit at operation 280. Finally, the method may include removing the seed container from the dispensing unit at operation 290.

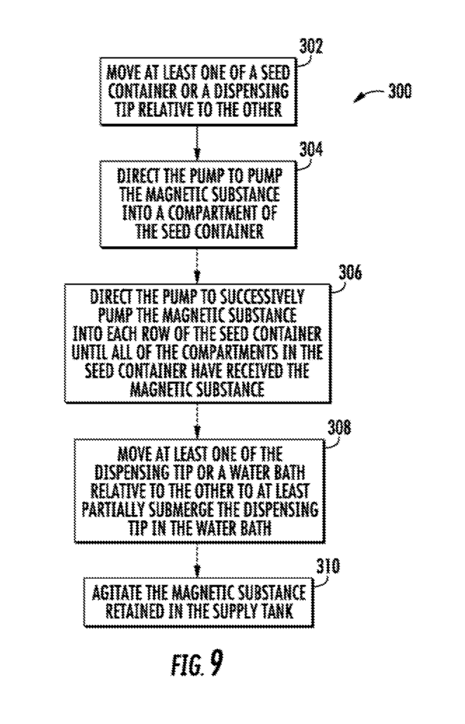

FIG. 9 illustrates another embodiment of a method for dispensing a substance on a seed. In the depicted embodiment, the method 300 comprises moving at least one of a seed container or a dispensing tip relative to the other at operation 302. The method further comprises directing the pump to pump the substance into a compartment of the seed container at operation 304.

In some embodiments, the plurality of compartments in the seed container are arranged in an array comprising a plurality of rows. In such an embodiment, the method may further comprise directing the pump to successively pump the substance into each row of the seed container until all of the compartments in the seed container have received the substance at operation 306. Additionally or alternatively, the method may further comprise moving at least one of the dispensing tip or a bath relative to the other to at least partially submerge the dispensing tip in the bath at operation 308. In some embodiments, the method may comprise moving at least one of the dispensing tip or a bath relative to the other to at least partially submerge the dispensing tip in the bath after directing the pump to pump the substance into each row of the seed container. For example, the method may comprise directing the pump to pump the substance into a single row of the seed container and then moving at least one of the dispensing tip or a bath relative to the other to at least partially submerge the dispensing tip in the bath before directing the pump to pump the substance into another row of the seed container. In various embodiments, the method may further comprise agitating the substance retained in the supply tank at operation 310. In various embodiments, the substance may comprise a magnetic substance (e.g., magnetic paint).

Many modifications and other embodiments of the invention set forth herein will come to mind to one skilled in the art to which these invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for automated dispensing of a substance on a seed, the system comprising:
a seed container comprising a plurality of compartments each compartment configured to retain a seed;
a supply tank configured to retain the substance;
at least one dispensing tip configured to dispense the substance;
a pump connected to the supply tank and to the dispensing tip and configured to pump the substance from the supply tank to the dispensing tip; and
a controller configured to move at least one of the seed container or the dispensing tip relative to the other and to direct the pump to pump the substance into a compartment of the seed container.

2. The system of claim 1 further comprising a bath, wherein the controller is further configured to move at least one of the dispensing tip or the bath relative to the other and to at least partially submerge the dispensing tip in the bath.

3. The system of claim 1, wherein the plurality of compartments in the seed container are arranged in an array comprising a plurality of rows.

4. The system of claim 3, wherein the pump comprises a plurality of channels that lead to a plurality of dispensing tips arranged substantially linearly, wherein the number of dispensing tips is equal to the number of compartments in each row of the seed container, and wherein the controller is configured to direct the plurality of channels to pump the substance into the rows of the seed container.

5. The system of claim 3, wherein the controller is configured to direct the pump to successively pump the substance into each row of the seed container until all of the compartments in the seed container have received the substance.

6. The system of claim 5 further comprising a bath, wherein the controller is further configured to move at least one of the bath or the dispensing tip relative to the other and to at least partially submerge the dispensing tip in the bath after all of the compartments in the seed container have received the substance.

7. The system of claim 1, wherein the substance comprises a magnetic substance.

8. The system of claim 7, wherein the magnetic substance is magnetic paint.

9. The system of claim 8, wherein the supply tank comprises an agitator configured to agitate the magnetic paint.

10. The system of claim 1, wherein the dispensing tip comprises a caliber defined by at least one of flow rate, substance type, or viscosity.

11. A method for automatically dispensing a substance on a seed, the method comprising:
moving at least one of a seed container or a dispensing tip relative to the other, wherein the seed container comprises a plurality of compartments each compartment configured to retain a seed, wherein the dispensing tip is connected to a pump and the pump is connected to a supply tank, wherein the supply tank is configured to retain the substance, and wherein the dispensing tip is configured to dispense the substance; and
directing the pump to pump the substance into a compartment of the seed container.

12. The method of claim 11 further comprising moving at least one of the dispensing tip or a bath relative to the other to at least partially submerge the dispensing tip in the bath.

13. The method of claim 11, wherein the plurality of compartments in the seed container are arranged in an array comprising a plurality of rows.

14. The method of claim 13, wherein the pump comprises a plurality of channels that lead to a plurality of dispensing tips arranged substantially linearly, wherein the number of dispensing tips is equal to the number of compartments in each row of the seed container, and wherein directing the pump to pump the substance into a compartment in the seed container comprises directing the plurality of channels to pump the substance into the rows of the seed container.

15. The method of claim 13 further comprising directing the pump to successively pump the substance into each row of the seed container until all of the compartments in the seed container have received the substance.

16. The method of claim 15 further comprising moving at least one of a bath or the dispensing tip relative to the other to at least partially submerge the dispensing tip in the bath after all of the compartments in the seed container have received the substance.

17. The method of claim 11, wherein the substance comprises a magnetic substance.

18. The method of claim 17, wherein the magnetic substance is magnetic paint.

19. The method of claim 18 further comprising agitating the magnetic paint retained in the supply tank.

20. The method of claim 11, wherein the dispensing tip comprises a caliber defined by at least one of flow rate, substance type, or viscosity.
